(19) United States
(12) Patent Application Publication
(10) Pub. No.: US 2017/0153698 A1
(43) Pub. Date: Jun. 1, 2017

(54) METHOD AND APPARATUS FOR PROVIDING A VIEW WINDOW WITHIN A VIRTUAL REALITY SCENE

(71) Applicant: Nokia Technologies Oy, Espoo (FI)

(72) Inventors: Adetokunbo Bamidele, Mountain House, CA (US); Olli Matias Kilpeläinen, Tampere (FI); Hui Zhou, Sunnyvale, CA (US)

(21) Appl. No.: 14/953,776

(22) Filed: Nov. 30, 2015

(51) Int. Cl. G06F 3/01; G06T 11/60; G06T 11/00

(52) U.S. Cl. CPC G06F 3/013; G06T 11/00; G06T 11/60

(57) ABSTRACT

A method, apparatus and computer program product provide the user of an immersive user interface with additional information beyond that provided by the virtual reality scene that is displayed via the immersive user interface. In the context of a method, a direction and orientation of a user of an immersive user interface are determined. The method also causes a virtual reality scene to be displayed via the immersive user interface based upon the direction and orientation of the user. The method further causes an image, different from the virtual reality scene, to be presented within a view window of the immersive user interface concurrent with display of the virtual reality scene. The image within the view window therefore provides additional imagery to the user, such as an image that is external to the virtual reality scene and/or an image of a different portion of the virtual reality scene.

### TECHNOLOGICAL FIELD

Example embodiments relate generally to the presentation of a virtual reality scene by an immersive user interface and, more particularly, to a method, apparatus and computer program product for presenting an image within a view window of the immersive user interface concurrent with the display of the virtual reality scene.

### BACKGROUND

Immersive user interfaces are being increasingly utilized for a variety of purposes. Immersive user interfaces may present a virtual reality scene to a user who may be engaged in gaming or other activities. With the advent of 360° and 720° panoramic visual images, the user experience has improved as the user of an immersive user interface is able to view different portions of the virtual reality scene, much in the same manner that a person views the real world. Moreover, the utilization of spatial audio signals in conjunction with the visual images presented by an immersive user interface adds to the dimensionality in which the user experiences a virtual reality scene.

As a result of the immersion of the user in a virtual reality scene, the user may be somewhat disconnected from the real world and their immediate surroundings. Thus, a user may have to occasionally cease the immersive experience in order to view their real world surroundings, thereby disrupting the immersive experience.

Additionally, as a result of the expansiveness of the virtual reality scene presented by the immersive user interface, a user may have difficulties in viewing all aspects of the virtual reality scene and may, instead, focus on one portion of the virtual reality scene and fail to recognize activities occurring in a different portion of the virtual reality scene, such as those portions located behind the user. In an effort to remain aware of activities occurring in all or many portions of the virtual reality scene, a user may be forced to repeatedly redirect their focus and, as a result, may not pay sufficient attention to any one portion of the virtual reality scene.

### BRIEF SUMMARY

A method, apparatus and computer program product are provided in accordance with an example embodiment in order to provide the user of an immersive user interface with additional information beyond that provided by the virtual reality scene that is displayed via the immersive user interface. For example, the method, apparatus and computer program product of an example embodiment may provide an image within a view window of the immersive user interface so as to provide additional imagery to the user, such as an image that is external to the virtual reality scene and/or an image of a different portion of the virtual reality scene. As such, the method, apparatus and computer program product of an example embodiment may permit the user to enjoy the virtual reality scene displayed via the immersive user interface while increasing the overall awareness of the user without requiring the user to redirect their line of sight or temporarily cease the immersive experience.

In accordance with an example embodiment, a method is provided that includes determining at least one of a direction and orientation of a user of an immersive user interface. The method also includes causing a virtual reality scene to be displayed via the immersive user interface based upon the at least one of direction and orientation of the user. The method further includes causing an image, different from the virtual reality scene, to be presented within a view window of the immersive user interface concurrent with display of the virtual reality scene.

The image to be presented within the view window may be an image external to the virtual reality scene. Alternatively, the image to be presented within the view window may be a different portion of the virtual reality scene. The method of an example embodiment may also include determining occurrence of a predefined cue. In this example embodiment, the method causes the image to be presented within the view window in a manner dependent upon the occurrence of the predefined cue. The method of this example embodiment may also include removing the image presented within the view window from the immersive user interface in an instance in which the predefined cue is determined to no longer be present.

The method of an example embodiment also includes detecting one or more regions of the virtual reality scene to which the user is attentive in positioning the view window within the virtual reality scene so as to be outside of the one or more regions of the virtual reality scene to which the user is attentive. The method of an example embodiment may also include identifying a plurality of images that are candidates for presentation within one or more view windows of the immersive user interface. In this example embodiment, the method also includes determining at least one of the plurality of images that are candidates for presentation to be presented within a view window based upon satisfaction of a predetermined criteria.

In another example embodiment, an apparatus is provided that includes at least one processor and at least one memory storing computer program code with the at least one memory and the computer program code configured to, with the processor, cause the apparatus to at least determine at least one of a direction and orientation of a user of an immersive user interface. The at least one memory and the computer program code are also configured to, with the processor, cause the apparatus to cause a virtual reality scene to be displayed via the immersive user interface based upon the at least one of direction and orientation of the user. The at least one memory and the computer program code are further configured to, with the processor, cause the apparatus to at least cause an image, different from the virtual reality scene, to be presented within a view window of the immersive user interface concurrent with display of the virtual reality scene.

The image to be presented within the view window may be an image external to the virtual reality scene. Alternatively, the image to be presented within a view window may be a different portion of the virtual reality scene. The at least one memory and the computer program code are further configured to, with the processor, cause the apparatus of an example embodiment to determine occurrence of a predefined cue. In this example embodiment, the image within the view window is caused to be presented in a manner dependent upon the occurrence of a predefined cue. The at least one memory and the computer program code are further configured to, with the processor, cause the apparatus of this example embodiment to remove the image presented within the view window from the immersive user interface in an instance in which the predefined cue is determined to no longer be present.

The at least one memory and the computer program code are further configured to, with the processor, cause the apparatus of an example embodiment to detect one or more regions of the virtual reality scene to which the user is attentive and to position the view window within the virtual reality scene so as to be outside the one or more regions of the virtual reality scene to which the user is attentive. The at least one memory and the computer program code are further configured to, with the processor, cause the apparatus of an example embodiment to identify a plurality of images that are candidates for presentation within one or more view windows of the immersive user interface and to determine at least one of the plurality of images that are candidates for presentation to be presented within the view window based upon satisfaction of a predetermined criteria.

In a further example embodiment, a computer program product is provided that includes at least one non-transitory computer-readable storage medium having computer-executable program code instructions stored therein with the computer-executable program code instructions including program code instructions configured to determine at least one of a direction and orientation of a user of an immersive user interface. The computer-executable program code instructions also include program code instructions configured to cause a virtual reality scene to be displayed via the immersive user interface based upon the at least one of direction and orientation of the user. The computer-executable program code instructions also include program code instructions configured to cause an image, different from the virtual reality scene, to be presented within a view window of the immersive user interface concurrent with display of the virtual reality scene.

The image to be presented within the view window may be an image external to the virtual reality scene. Alternatively, the image to be presented within the view window may be a different portion of the virtual reality scene. The computer-executable program code instructions may also include program code instructions configured to determine the occurrence of a predefined cue with the image within the view window being presented in a manner dependent upon the occurrence of the predefined cue. The computer-executable program code instructions of this example embodiment may also include program code instructions configured to remove the image presented within the view window from the immersive user interface in an instance in which the predefined cue is determined to no longer be present. The computer-executable program code instructions of an example embodiment may also include program code instructions configured to detect one or more regions of the virtual reality scene to which the user is attentive and to position the view window within the virtual reality scene so as to be outside of the one or more regions of the virtual reality scene to which the user is attentive.

In yet another example embodiment, an apparatus is provided that includes means for determining at least one of a direction and orientation of a user of an immersive user interface. The apparatus of this example embodiment also include means for causing the virtual reality scene to be displayed via the immersive user interface based upon the at least one of direction and orientation of the user. The apparatus of this example embodiment also include means for causing an image, different from the virtual reality scene, to be presented within a view window of the immersive user interface concurrent with the display of the virtual reality scene.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a perspective view of a user donning an immersive user interface in accordance with an example embodiment;

FIG. 2 is a virtual reality scene displayed by an immersive user interface and an image presented within a view window of the immersive user interface in accordance with an example embodiment;

FIG. 3 is a block diagram of an apparatus that may be specifically configured in accordance with an example embodiment;

FIG. 4 is a flowchart illustrating operations performed, such as by the apparatus of FIG. 3, in accordance with an example embodiment;

FIG. 5 illustrates a virtual reality scene displayed by an immersive user interface and an image of a different portion of the virtual reality scene presented within a view window of the immersive user interface in accordance with an example embodiment;

FIG. 6 is a flowchart illustrating operations performed, such as by the apparatus of FIG. 3, in order to position the view window in accordance with an example embodiment;

FIG. 7 is a flowchart illustrating operations performed, such as by the apparatus of FIG. 3, in order to determine one or more of a plurality of images to be presented within the view window in accordance with an example embodiment;

FIG. 8 illustrates a virtual reality scene and a plurality of images presented within a plurality of respective view windows of the immersive user interface in accordance with an example embodiment; and

FIG. 9 illustrates the concurrent capture of a scene by a plurality of cameras in order to create a virtual reality scene that may be displayed via the immersive user interface of an example embodiment.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

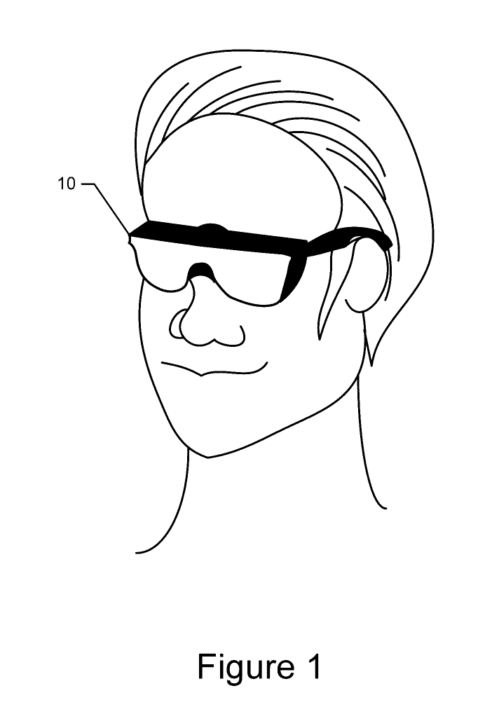

A method, apparatus and computer program product are provided in accordance with an example embodiment in order to present a virtual reality scene via an immersive user interface concurrent with an image, different than the virtual reality scene, that is presented in a view window of the immersive user interface. A virtual reality scene may be presented by a variety of immersive user interfaces. As shown in FIG. 1, the immersive user interface may include goggles, glasses or another head-mounted device 10 that is configured to present the virtual reality scene to the user. In order to enhance the immersion of the user in the virtual reality scene, the immersive user interface may be configured to limit or prevent the view by the user of the real world, such as by limiting or preventing a user's peripheral view of the real world. In order to increase the pervasiveness of the user's immersive experience, the immersive user interface may be configured to not only visually present the virtual reality scene, but also to concurrently provide audio signals, such as spatial audio signals, that were recorded and are associated with the virtual reality scene.

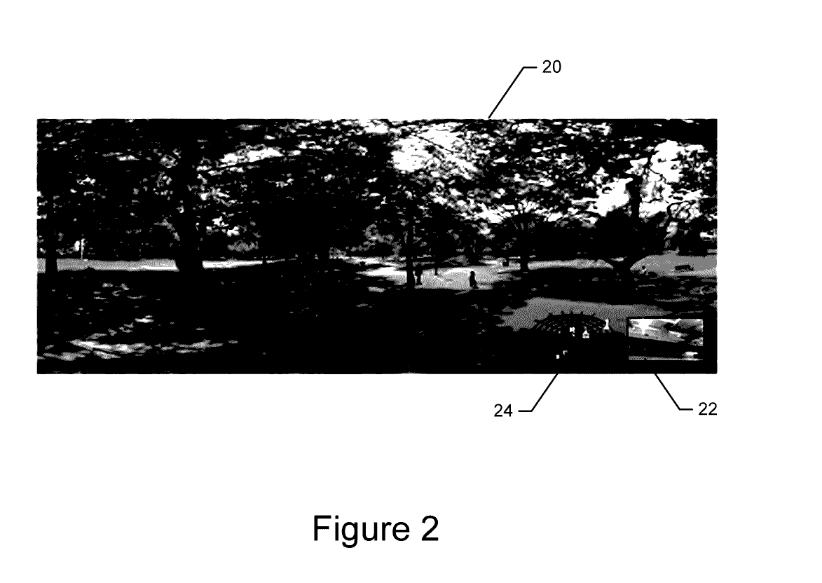

As shown in FIG. 2, the method, apparatus and computer program product of an example embodiment are configured to cause a virtual reality scene to be displayed via an immersive user interface 20. The virtual reality scene may be comprised of video images or still images that have been captured, such as by a camera or other image capturing device. Although the images that form the virtual reality scene, such as either still images or video images, may be captured in various manners, a virtual reality scene of an example embodiment is formed of a 360° panoramic image or a 720° panoramic image in order to further enhance the immersion of the user in the virtual reality world. Alternatively, the virtual reality scene may be an animated or computer-generated scene, such as in conjunction with various gaming applications.

As shown in FIG. 2 and described in greater detail below, the method, apparatus and computer program product of an example embodiment may also cause an image, different from the virtual reality scene, to be presented within a view window 22 of the immersive user interface 20 concurrent with the display of the virtual reality scene. The image presented within the view window may be any of a variety of different types of images including an image of the real world external to the immersive user interface and proximate the user or an image of a different portion of the virtual reality scene from that portion of the virtual reality scene that is displayed via the immersive user interface and is the subject of the user's attention. In regards to the example embodiment depicted in FIG. 2, an image of the real world external to the immersive user interface and proximate the user is presented in the view window. As such, the image presented within the view window permits the user to remain immersed in the virtual reality world while remaining aware of other situations, such as the external real world proximate the user as shown in FIG. 2 or other portions of the virtual reality scene to which the user is not currently focused.

The virtual reality scene and the image presented within the view window 22 of the immersive user interface 20 may be provided an apparatus 30 in accordance with an example embodiment. The apparatus may be configured in various manners. For example, the apparatus may be embodied by a computing device carried by or otherwise associated with the immersive user interface 20, such as may, in turn, be embodied by a head-mounted device 10. Alternatively, the apparatus may be embodied by a computing device, separate from the immersive user interface, but in communication therewith. Still further, the apparatus may be embodied in a distributed manner with some components of the apparatus embodied by the immersive user interface and other components of the apparatus embodied by a computing device that is separate from, but in communication with, the immersive user interface. In those example embodiments in which the apparatus is embodied, either entirely or partly, so as to be separate from, but in communication with the immersive user interface, the apparatus may be embodied by any of a variety of computing devices, including, for example, a mobile terminal, such as a portable digital assistant (PDA), mobile telephone, smartphone, pager, mobile television, gaming device, laptop computer, camera, tablet computer, touch surface, video recorder, audio/video player, radio, electronic book, positioning device (e.g., global positioning system (GPS) device), or any combination of the aforementioned, and other types of voice and text communications systems. Alternatively, the computing device may be a fixed computing device, such as a personal computer, a computer workstation, a server or the like.

Regardless of the manner in which the apparatus 30 is embodied, the apparatus of an example embodiment is configured to include or otherwise be in communication with a processor 32 and a memory device 34 and optionally the user interface 36, a communication interface 38 and/or one or more sensors 40. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the apparatus 30 may be embodied by a computing device and/or the immersive user interface 20. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 32 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 32 may be configured to execute instructions stored in the memory device 34 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the apparatus 30 may include a user interface 36 that may, in turn, be in communication with the processor 32 to provide output to the user and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. For example, in embodiments in which the apparatus is embodied by the immersive user interface 20, the user interface may include the immersive user interface that presents the virtual reality scene and the view window 22 and the user interface may include an input mechanism to permit a user to alternately actuate and pause (or terminate) operation of the immersive user interface. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., memory device 34, and/or the like).

The apparatus 30 may optionally include the communication interface 38, such as in instances in which the apparatus is embodied by a computing device that is separate from, but in communication with, the immersive user interface 20. The communication interface may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms

The apparatus 30 of the example embodiment may optionally include one or more sensors 40. As described below, the sensors may include sensors configured to determine the at least one of direction and orientation of the user of the immersive user interface 20, such as an accelerometer, a magnetometer, a gyroscope or the like. Further, the sensors of an example embodiment may include sensors, such as one or more cameras, for determining the portion of the virtual reality scene presented by the immersive user interface to which the user is attentive. In an example embodiment, the one or more cameras may capture images of the eyes of the user to permit the portion of the virtual reality scene presented by the immersive user interface to which the user is attentive to be determined, such as by the processor 32. The apparatus may include other types of sensors in other embodiments.

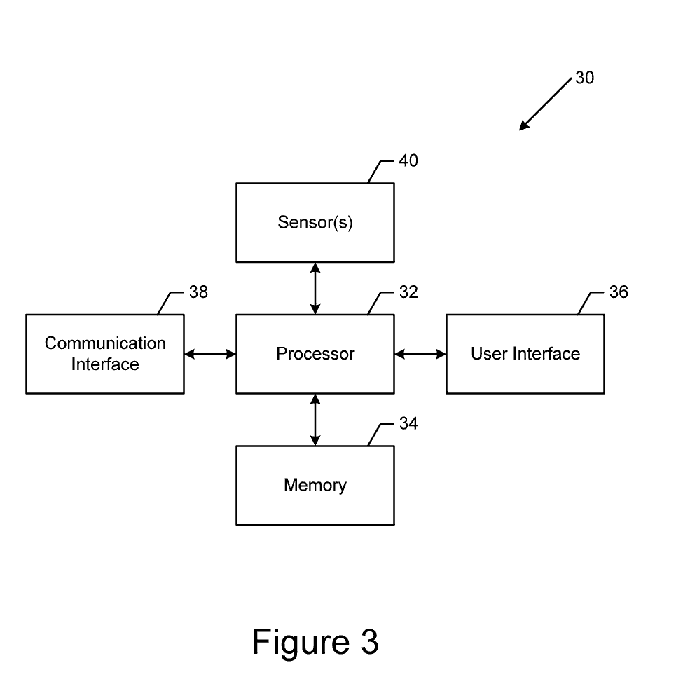

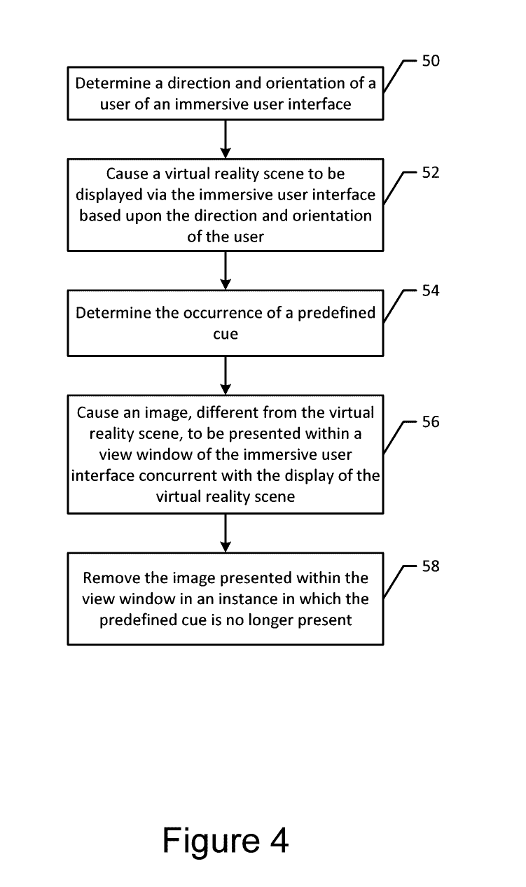

Referring now to FIG. 4, the operations performed, such as by the apparatus 30 of FIG. 3, in order to present both a virtual reality scene and an additional image within a view window 22 of the immersive user interface 20 in accordance with an example embodiment are depicted. As shown in block 50 of FIG. 4, the apparatus includes means, such as the sensors 40 or the like, for determining at least one of the direction and orientation of the user of the immersive user interface. In this regard, the sensors may include a magnetometer, accelerometer, a gyroscope or other type of sensor for detecting the direction and orientation of the user, such as the direction and orientation of the user's head upon which the immersive user interface is mounted. In an example embodiment, the immersive user interface includes or otherwise carries the sensors in order to detect the direction and orientation of the user of the immersive user interface.

The apparatus 30 also includes means, such as the processor 32, the user interface 36, the communication interface 38 or the like, for causing a virtual reality scene to be displayed via the immersive user interface 20 based upon the at least one of direction and orientation of the user. See block 52 of FIG. 4. In an example embodiment, the particular portion of the virtual reality scene that is to be displayed may be associated with, such as by being defined by, the predefined direction and orientation of the user. By determining the direction and orientation of the user, such as relative to a predefined direction and orientation associated with a predetermined portion of the virtual reality scene, the processor of an example embodiment is configured to determine the portion of the virtual reality scene to be presented by the immersive user interface. By repeatedly comparing the current direction and orientation of the user to the predefined direction and orientation associated with a predetermined portion of the virtual reality scene, the processor of an example embodiment is configured to repeatedly update the portion of the virtual reality scene that is presented by the immersive user interface so as to track the direction and orientation in which the user is looking. Thus, in an instance in which a user turns their head to the right, the portion of the virtual reality scene to the right of the previously displayed portion of the virtual reality scene may be presented. Alternatively, in an instance in which the user turns their head to the left and looks upwardly, the portion of the virtual reality scene to the left and above the portion of the virtual reality scene that was previously displayed may be presented.

As shown in block 56 of FIG. 4, the apparatus 30 also includes means, such as the processor 32, the user interface 36, the communication interface 38 or the like, for causing an image, different from the virtual reality scene, to be presented within the view window 22. Various different types of images may be presented within the view window of the immersive user interface 20. As shown within the view window of the immersive user interface of FIG. 2, the image may be an image of the real world external to the immersive user interface and proximate the user. For example, the image of the real world may be an image of the real world external to the immersive user interface and in the direction in which the user is currently facing or an image of the real world external to the immersive user interface and in the opposite direction to that in which the user is facing, that is, the image behind the user. Although the image may be captured in various manners, the immersive user interface of an example embodiment may include a camera or other image capturing device for capturing an image of the real world proximate user for presentation within the view window of the immersive user interface. In instances in which the image presented within the view window of the immersive user interface is an image of the real world proximate the user, the image may be captured in real time or substantially in real time with respect to the presentation of the image. The view window may continue to present an image for various lengths of time, such as until a user provides input directing the image to be removed or for a predetermined length of time. In this regard, the view window may be configured to present an image for a length of time that is predetermined based upon the type of image, such that a first type of image is presented for a longer period of time than a second type of image.

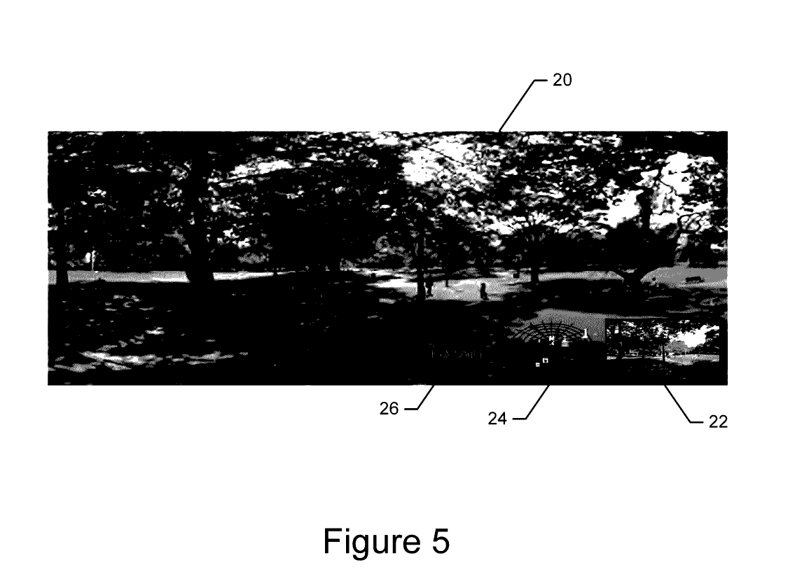

Alternatively, the image that is presented within the view window 22 may be a different portion of the virtual reality scene that is presented by the immersive user interface 20. As shown in FIG. 5, for example, the image presented within the view window is a different portion of a virtual reality scene from that which is the current focus of the user. For example, the portion of the virtual reality scene that is presented within the view window may be an image of the virtual reality scene that is immediately behind the user relative to the direction and orientation of the user, such as the image of the virtual reality scene that is located 180° from the current direction of focus of the user. As such, the user may be alerted of activity behind the user in the virtual reality scene, while maintaining their focus in the direction and orientation in which the user is facing. The user may be alerted, such as of activity, a person, etc. that has been detected, outside of the image of the virtual reality scene in various manners including by the presentation of an alert message 26, e.g., look South. The image that is presented within the view window of the immersive user interface may not only be an image of the real world external to the immersive user interface and proximate to the user or an image drawn from a different portion of the virtual reality scene, but may be other images in other example embodiments.

In an example embodiment, the apparatus 30 may also optionally include means, such as the processor 32, the sensors 40 or the like, for determining the occurrence of a predefined cue as shown in block 54 of FIG. 4. A variety of predefined cues may be defined including, for example, the identification by the processor of a particular individual, such as may be detected via face and/or voice recognition, in the virtual reality scene or in the image of the real world external to the immersive user interface 20. As another example, a predefined cue may be indicative of the occurrence of certain activities or noises, such as a person running, a car driving, a scream, the utterance of the user's name, or the like. These actions or noises may be detected in the virtual reality scene based upon an analysis by the processor of the virtual reality scene and/or the audible signals associated therewith or in the image of the real world external to the immersive user interface based upon an analysis by the processor of the image(s) captured by the camera or other image capturing device. Additional or different predefined cues may be utilized in other example embodiments. The predefined cues may be defined in advance, such as by settings associated with the immersive user interface or may be defined based on an analysis, such as by the processor, of the objects to which the user is most attentive during their viewing of the virtual reality scene. For example, if the processor determines, such as by use of an attention detection technique as described, for example, by Ari Borji, et al., “State-of-the Art in Visual Attention Modeling”, IEEE Transactions on Pattern Analysis and Machine Intelligence, Vol. 35, No. 1 (January 2013) and F. W. M. Stentiford, “An Evolutionary Programming Approach to the Simulation of Visual Attention”, Proceedings of the 2001 IEEE Congress on Evolutionary Computation (May 27-30, 2001), that the user pays the most attention to that portion of the virtual reality scene that includes a particular individual, the particular individual may serve as the predefined cue. Thus, in instances in which the apparatus, such as the processor, identifies the particular individual in some portion of the virtual reality scene that is not currently the focus of the user, an image of that portion of the virtual reality scene that includes the particular individual may be presented in the view window 22.

In this example embodiment, the apparatus 30, such as the processor 32, the user interface 36, the communication interface 38 or the like, is configured to cause the image to be presented within the view window 22 in a manner, such as a substantive and/or temporal manner, that is dependent upon the occurrence of a predefined cue. Thus, from a temporal perspective, an image may only be presented within the view window in an instance in which the predefined cue has been detected. Additionally or alternatively, from a substantive perspective, the actual image that is presented within the view window may be dependent upon the predefined cue so as to include an image that captures the predefined cue.

As shown in block 58 of FIG. 4, the apparatus 30 of this example embodiment also optionally includes a means, such as the processor 32, the user interface 36, the communication interface 38 or the like, for removing the image presented within the view window 22 from the immersive user interface 20 in an instance in which the predefined cue is determined to no longer be present. Thus, in an instance in which the processor determines that the predefined cue is no longer present, such as in an instance in which a particular person that serves as the predefined cue is no longer present within the virtual reality scene, the image presented within the view window may be removed. Thus, an image may not always be presented within the view window, but may only be presented while a predefined cue is present. Alternatively, the image may be removed from the view window in an instance in which another predefined cue, such as a predefined cue of a higher priority, is detected.

The apparatus 30 of an example embodiment is also configured to optionally present a map 24 or other designation of the location of the user. As shown in FIGS. 2 and 5, for example, a map may be presented by the immersive user interface 20 that indicates the location of the user relative to other objects, such as points of interest, other people or the like. In this example embodiment of a map, the user of the immersive user interface may be located at the center of the grid with icons representative of other points of interest or other people, such as other people engaged in the same game, designated upon the grid.

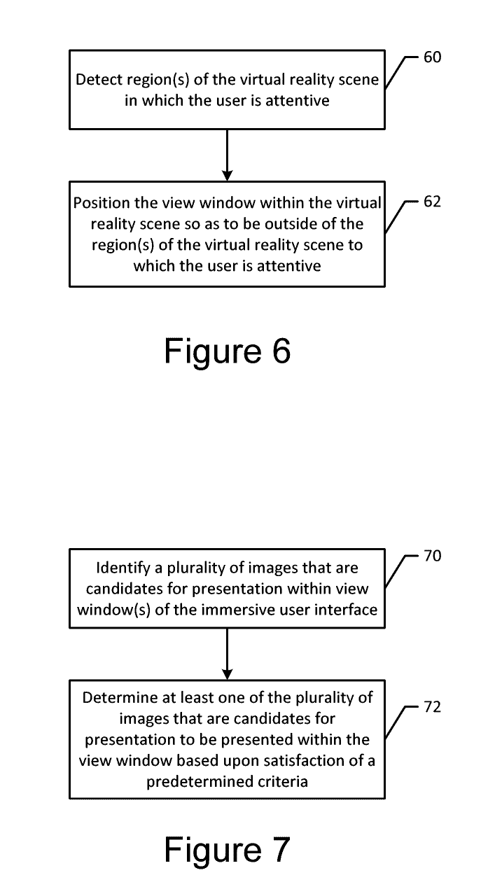

Referring now to FIG. 6, the apparatus 30 of an example embodiment may also be configured to controllably position the location of the view window 22 relative to the virtual reality scene displayed by the immersive user interface 20 based upon the user's attentiveness, such as based upon those regions of the virtual reality scene to which the user pays the most attention. In this example embodiment and as shown in block 60 of FIG. 6, the apparatus includes means, such as the processor 32, the sensors 40 or the like, for detecting one or more regions of the virtual reality scene to which the user is attentive. The attentiveness of the user may be determined in various manners. In an example embodiment, however, the processor is configured to utilize an attention detection technique, such as described by Ari Borji, et al., “State-of-the Art in Visual Attention Modeling”, IEEE Transactions on Pattern Analysis and Machine Intelligence, Vol. 35, No. 1 (January 2013) and F. W. M. Stentiford, “An Evolutionary Programming Approach to the Simulation of Visual Attention”, Proceedings of the 2001 IEEE Congress on Evolutionary Computation (May 27-30, 2001), in order to identify those regions of the virtual reality scene to which the user is most attentive.

In this example embodiment and as shown in block 62 of FIG. 6, the apparatus 30 also includes means, such as the processor 32, the user interface 36, the communication interface 38 or the like, for positioning the view window 22 within the virtual reality scene so as to be outside of the one or more regions of the virtual reality scene to which the user is attentive and to, instead, overlie a region of the virtual reality scene to which the user is less attentive or to which the user is not attentive at all. Thus, the view window is placed relative to the virtual reality scene so as not to be disruptive to the user's view of the virtual reality scene and those regions of the virtual reality scene to which the user is most attentive. Instead, the view window is placed in the location relative to the virtual reality scene to which the user has paid less, if any, attention, such as in the lower right corner of the immersive user interface 20 of FIGS. 2 and 5.

The view window 22 may be presented by the processor 30 upon the immersive user interface 20 in various manners. For example, the view window may be overlaid upon the virtual reality scene, such as by alpha blending. Alternatively, a portion of the virtual reality scene may be blanked and the view window be inserted or inset within the blanked portion of the virtual reality scene.

Although a single view window, for example the view window 22, is presented by the immersive user interface 20 in the example embodiments described above and depicted in FIGS. 2 and 5, two or more view windows that present different images may be provided in other example embodiments. In this regard and as shown in block 70 of FIG. 7, the apparatus 30 of an example embodiment includes means, such as the processor 32 or the like, for identifying a plurality of images that are candidates for presentation within one or more view windows of the immersive user interface. For example, the processor of an example embodiment may be configured to identify the plurality of images based upon the satisfaction of a plurality of different predefined cues with each predefined cue having a different image associated therewith. Alternatively, the plurality of images that are identified as candidates for presentation may be of different types with at least one of the images being an image of real world external to the immersive user interface, while another image is an image of the virtual reality scene that is offset from that portion of the virtual reality scene upon which the user is currently focused.

In an embodiment in which a plurality of images that are candidates for presentation within the view window 22 have been identified, the apparatus 30 also includes means, such as the processor 32 or the like, for determining at least one of the plurality of images and, in some embodiments, a plurality of the images that are candidates for presentation to be presented within the view window based upon satisfaction of a predetermined criteria. See block 72 of FIG. 7. The predetermined criteria may be defined in various manners in order to establish a relative prioritization of the plurality of images that are candidates for presentation. For example, the predetermined criteria may be based upon the type of image with images of the real world external to the immersive user interface receiving priority relative to images of other portions of the virtual reality scene. In this example embodiment, the identification of a plurality of images as candidates for presentation that include at least one image of the real world external to the immersive user interface would be considered to satisfy the predetermined criteria. The predetermined criteria of this embodiment may also be based upon the user profile such that images that are contextually relevant to the user as defined by the user profile are given priority for presentation. For example, the user profile may indicate that the user is in the military, is engaged in police reconnaissance or involved in sports such that images that are contextually relevant to military operations, police reconnaissance or sports, respectively, are prioritized. Alternatively, in an environment in which a plurality of predefined cues are identified, the predefined criteria may define a prioritization amongst the different predefined cues such that the image that is associated with the predefined cue having the highest priority from among the predefined cues that were satisfied is determined to also satisfy the predetermined criteria and be presented via the view window.

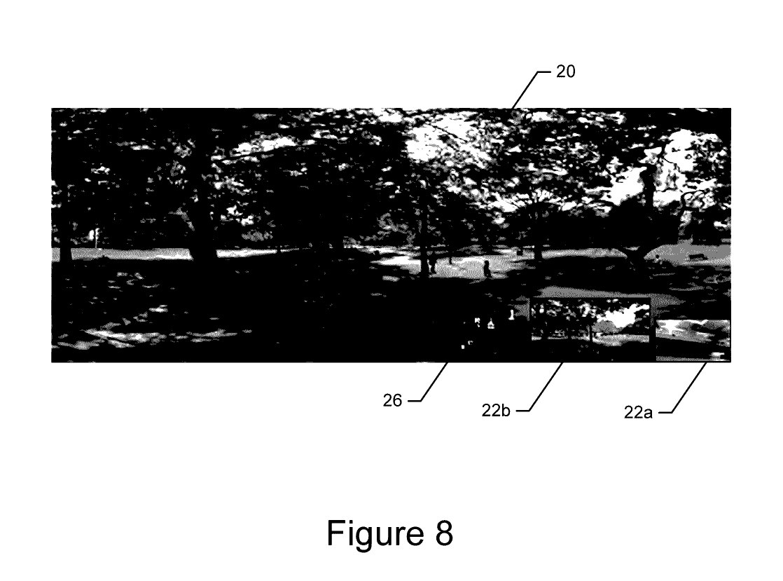

As shown in FIG. 8, a plurality of images may be presented within respective view windows 22a, 22b in some embodiments, such as in embodiments in which a plurality of the images that are candidates for presentation each satisfy the predetermined criteria. The placement of the plurality of view windows of this embodiment may also be based upon the relative prioritization of the different images with the view window that presents the image having the greatest prioritization being positioned more prominently than the view window(s) that present the other image(s).

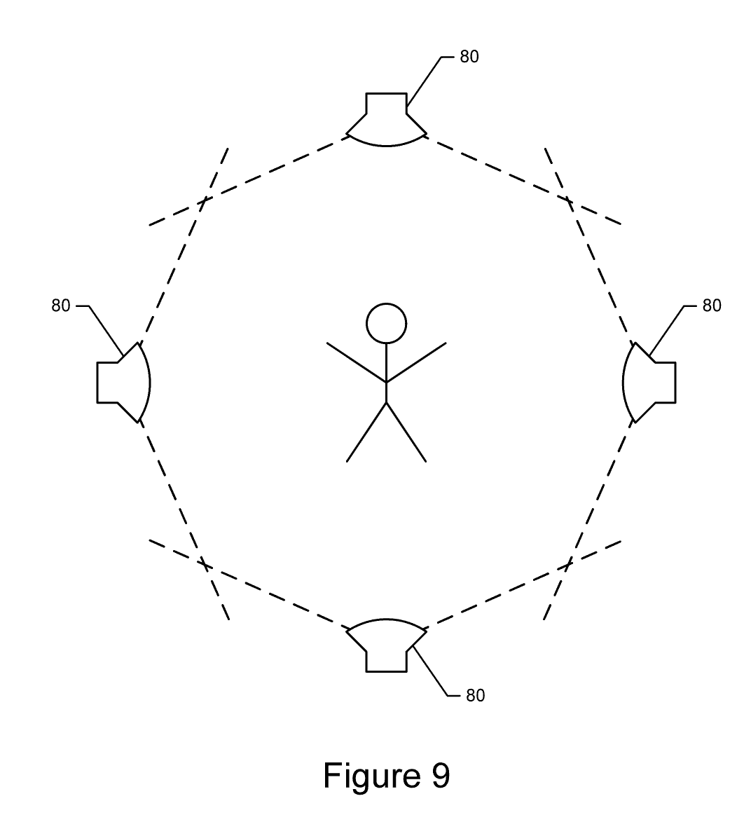

The virtual reality scene may be depicted by images captured in various manners or by animated or computer-generated scenes. In an example embodiment, images of the same scene may be captured by a plurality of cameras 80 or other image capturing devices as shown in FIG. 9. The images captured by the plurality of cameras may be combined to form the virtual reality scene. By altering the direction and orientation in which the user views the virtual reality scene, the user may view different portions of the virtual reality scene. Thus, by continuing to focus on a particular portion of the virtual reality scene, the user may view a different story line from within the virtual reality scene than user would view in an instance in which the user focused upon a different portion of the same virtual reality scene.

Regardless of the type of images that comprise the virtual reality scene, the provision of the view window 22 in which an image is presented by the immersive user interface 20 concurrent with the virtual reality scene permits the user to remain focused upon the virtual reality scene while maintaining awareness of other images, such images of the real world external to the immersive user interface or images from a different portion of the virtual reality scene. Consequently, the user need not prematurely end their immersion, such as to check on their surroundings in the real world, but may maintain their immersion in an informed manner. Additionally or alternatively, the user may maintain their focus upon a region of the virtual reality scene while also having an awareness of other regions of the virtual reality scene, such as via the image(s) presented via the view window(s).

As described above, FIGS. 4, 6 and 7 illustrate flowcharts of an apparatus 30, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 34 of an apparatus employing an embodiment of the present invention and executed by the processor 32 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining at least one of a direction and orientation of a user of an immersive user interface;
causing a virtual reality scene to be displayed via the immersive user interface based upon the at least one of direction and orientation of the user; and
causing an image, different from the virtual reality scene, to be presented within a view window of the immersive user interface concurrent with display of the virtual reality scene.

2. A method according to claim 1 wherein causing the image to be presented within the view window comprises causing presentation of an image external to the virtual reality scene within the view window.

3. A method according to claim 1 wherein causing the image to be presented within the view window comprises causing presentation of a different portion of the virtual reality scene within the view window.

4. A method according to claim 1 further comprising determining occurrence of a predefined cue, wherein causing the image to be presented within the view window comprises causing the image to be presented within the view window in a manner dependent upon the occurrence of the predefined cue.

5. A method according to claim 4 further comprising removing the image presented within the view window from the immersive user interface in an instance in which the predefined cue is determined to no longer be present.

6. A method according to claim 1 further comprising:
detecting one or more regions of the virtual reality scene to which the user is attentive; and
positioning the view window within the virtual reality scene so as to be outside of the one or more regions of the virtual reality scene to which the user is attentive.

7. A method according to claim 1 further comprising:
identifying a plurality of images that are candidates for presentation within one or more view windows of the immersive user interface; and
determining at least one of the plurality of images that are candidates for presentation to be presented within the view window based upon satisfaction of a predetermined criteria.

8. A method according to claim 1 further comprising causing an alert message to be displayed.

9. A method according to claim 1 further comprising causing a designation of a location of the user to be displayed.

10. An apparatus comprising at least one processor and at least one memory storing computer program code, the at least one memory and the computer program code configured to, with the processor, cause the apparatus to at least:
determine at least one of a direction and orientation of a user of an immersive user interface;
cause a virtual reality scene to be displayed via the immersive user interface based upon the at least one of direction and orientation of the user; and
cause an image, different from the virtual reality scene, to be presented within a view window of the immersive user interface concurrent with display of the virtual reality scene.

11. An apparatus according to claim 10 wherein the at least one memory and the computer program code are configured to, with the processor, cause the apparatus to cause the image to be presented within the view window by causing presentation of an image external to the virtual reality scene within the view window.

12. An apparatus according to claim 10 wherein the at least one memory and the computer program code are configured to, with the processor, cause the apparatus to cause the image to be presented within the view window by causing presentation of a different portion of the virtual reality scene within the view window.

13. An apparatus according to claim 10 wherein the at least one memory and the computer program code are further configured to, with the processor, cause the apparatus to determine occurrence of a predefined cue, and wherein the at least one memory and the computer program code are configured to, with the processor, cause the apparatus to cause the image to be presented within the view window by causing the image to be presented within the view window in a manner dependent upon the occurrence of the predefined cue.

14. An apparatus according to claim 13 wherein the at least one memory and the computer program code are further configured to, with the processor, cause the apparatus to remove the image presented within the view window from the immersive user interface in an instance in which the predefined cue is determined to no longer be present.

15. An apparatus according to claim 10 wherein the at least one memory and the computer program code are further configured to, with the processor, cause the apparatus to:
detect one or more regions of the virtual reality scene to which the user is attentive; and
position the view window within the virtual reality scene so as to be outside of the one or more regions of the virtual reality scene to which the user is attentive.

16. An apparatus according to claim 10 wherein the at least one memory and the computer program code are further configured to, with the processor, cause the apparatus to:
identify a plurality of images that are candidates for presentation within one or more view windows of the immersive user interface; and
determine at least one of the plurality of images that are candidates for presentation to be presented within the view window based upon satisfaction of a predetermined criteria.

17. An apparatus according to claim 10 wherein the at least one memory and the computer program code are further configured to, with the processor, cause the apparatus to cause an alert message to be displayed.

18. An apparatus according to claim 10 wherein the at least one memory and the computer program code are further configured to, with the processor, cause the apparatus to cause a designation of a location of the user to be displayed.

19. A computer program product comprising at least one non-transitory computer-readable storage medium having computer-executable program code instructions stored therein, the computer-executable program code instructions comprising program code instructions configured to:
determine at least one of a direction and orientation of a user of an immersive user interface;
cause a virtual reality scene to be displayed via the immersive user interface based upon the at least one of direction and orientation of the user; and
cause an image, different from the virtual reality scene, to be presented within a view window of the immersive user interface concurrent with display of the virtual reality scene.

20. A computer program product according to claim 19 wherein the program code instructions configured to cause the image to be presented within the view window comprise program code instructions configured to cause presentation of an image external to the virtual reality scene within the view window.

21. A computer program product according to claim 19 wherein the program code instructions configured to cause the image to be presented within the view window comprise program code instructions configured to cause presentation of a different portion of the virtual reality scene within the view window.

22. A computer program product according to claim 19 wherein the computer-executable program code instructions further comprise program code instructions configured to determine occurrence of a predefined cue, and wherein the program code instructions configured to cause the image to be presented within the view window comprise program code instructions configured to cause the image to be presented within the view window in a manner dependent upon the occurrence of the predefined cue.

23. A computer program product according to claim 22 wherein the computer-executable program code instructions further comprise program code instructions configured to remove the image presented within the view window from the immersive user interface in an instance in which the predefined cue is determined to no longer be present.

24. A computer program product according to claim 19 wherein the computer-executable program code instructions further comprise program code instructions configured to:
detect one or more regions of the virtual reality scene to which the user is attentive; and
position the view window within the virtual reality scene so as to be outside of the one or more regions of the virtual reality scene to which the user is attentive.
